(19) United States
(12) Patent Application Publication
(10) Pub. No.: US 2014/0101239 A1
(43) Pub. Date: Apr. 10, 2014

(54) Systems and Methods for Turning Social Networking Website Usage Information into a Social Networking Website Game

(71) Applicant: Esposito Intellectual Enterprises, L.L.C., Belmar, NJ (US)

(72) Inventor: Brian J. Esposito, Belmar, NJ (US)

(73) Assignee: Esposito Intellectual Enterprises, L.L.C., Belmar, NJ (US)

(21) Appl. No.: 14/049,462

(22) Filed: Oct. 9, 2013

Related U.S. Application Data
(60) Provisional application No. 61/711,834, filed on Oct. 10, 2012.

(51) Int. Cl. H04L 29/08

(52) U.S. Cl. CPC H04L 67/1091
USPC 709/203

(57) ABSTRACT

A method and system are disclosed for providing a game within a social networking website that uses usage information from the social networking website to score the game. Social networking website usage information of a social networking website for one or more users is stored in one or more databases. The social networking website usage information is accessed from the one or more databases using one or more computer servers. A game score is calculated for one or more users of the social networking website based on the social networking website usage information using the one or more computer servers. The game score is displayed to the one or more users on one or more client devices using the one or more computer servers.

### CROSS-REFERENCE TO RELATED APPLICATION

This application claims the benefit of U.S. Provisional Patent Application No. 61/711,834 filed Oct. 10, 2012.

### INTRODUCTION

1. Technical Field

Various embodiments relate to systems and methods for (1) turning the very use of social networks, such as Facebook, LinkedIn, etc., into a game itself, and (2) increasing site traffic and activity on social networks as a result of its gaming approach. Whereas, users of these types of social networks are assigned points for different types of activities on and off of a particular network. Various embodiments turn the social environment into a scoreboard to establish a competitive environment for the users to track the use of the network itself, as well as, other offline activities of daily living that are tracked and posted to the users account to determine a members standing against their peers in the game created. Particularly, various embodiments create a competitive environment that results in increased traffic and activity for the social network. More particularly, various embodiments collect data, assign scores, and rank members in the use of such networks. Various embodiments are also further applicable to assigning points and scores to activity outside of the particular social environment, thus turning life activities into game points themselves.

2. Background Information

Currently, social networks seek to promote the membership, use of the networks functions, and member activity and repetitive logins, which result in greater retention rates and advertising/sponsorship dollars—valuation. Several large social networks have included games on the platform, which existing members can play with one another. However, none of these social networks incorporate the various embodiments described herein, which turn the use of the social networking website itself into a game.

### SUMMARY

Various embodiments center around the innovative concept of utilizing currently available user statistics on social media use, coupled with externally sourced statistics to be stored in databases then applying mathematical calculations to that data to determine scores/ranking. Once scores are established, this information is passed back to a scoreboard, which is displayed within the social setting that displays the member scores and that of his/her peer group along with his/her ranking in the group. A clear understanding of the key features of the summarized above may be had by reference to the appended drawings, which illustrate various systems and methods, although it will be understood that such drawings depict preferred embodiments and, therefore, are not to be considered as limiting its scope with regard to other embodiments.

Various embodiments described herein can increase the utilization of specific functions on the existing network. These embodiments can increase the use of the network including frequency of user logins. These embodiments can also provide a commercially practicable method for scoring activities of daily living in such a manner that a member's outside activities contribute points to the social setting scoreboard and game play.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary screenshot of a window of a social networking website usage game application from a social networking website that shows a user's total score, current ranking with respect to other users, and sub-scores for various social networking website activity, in accordance with various embodiments.

FIG. 3 is an exemplary screenshot of a window of a social networking website usage game application from a social networking website that shows friends that can be invited to join the social networking website usage game application, in accordance with various embodiments.

FIG. 4 is an exemplary screenshot of a window of a social networking website usage game application from a social networking website that shows the standings or rankings of friends' game scores in graphical form, in accordance with various embodiments.

FIG. 5 is a schematic diagram of a system for providing a game within a social networking website that uses usage information from the social networking website to score the game, in accordance with various embodiments.

FIG. 6 is a flowchart showing a method for providing a game within a social networking website that uses usage information from the social networking website to score the game, in accordance with various embodiments.

FIG. 7 is a schematic diagram of a system that includes one or more distinct software modules that performs a method for providing a game within a social networking website that uses usage information from the social networking website to score the game, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

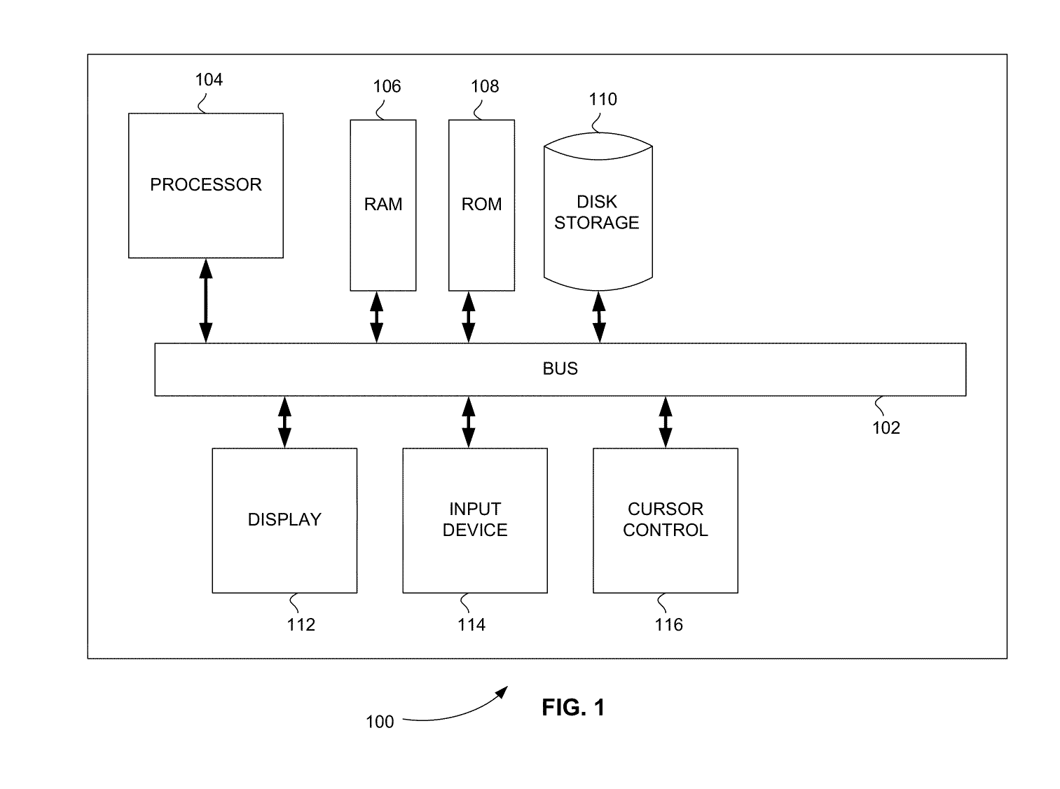

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The other computer systems that send and receive data to and from the servers or the cloud can be referred to as client or cloud devices, for example. A computer system is synonymous with a computer server, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can be coupled to bus 102 through a wired or wireless network, and the instructions can be sent across the wired or wireless network to bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a non-transient, tangible computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. A computer-readable medium is synonymous with a computer program product, for example.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Social Networks

As described above, various embodiments center around the innovative concept of utilizing currently available user statistics on social media use, coupling user statistics with externally sourced statistics, storing the resulting statistics in databases, and applying mathematical calculations to the stored statistics to determine user scores and ranking. Once scores are established, this information is passed back to a scoreboard, which is displayed within the social setting. This scoreboard, for example, displays the member scores and that of his/her peer group along with his/her ranking in the group. Additional activities, both within the social networking environment and offline can be created. These activities can include, but are not limited to, playing games, contributing to non-profit organizations, contributing to online information databases like Wikipedia, providing product recommendations, or volunteering. Additional points can be obtained by participating in the activity and reporting activity in the social networking website system.

Scoring for the system is based upon general activities carried out while participating in social networking activities. Social networking activities include, but are not limited to, uploading photographs, “liking” posts, photographs, and links, obtaining friends, and recommending products. Data for this information is available within a social networking website, for example, via their developer application programming interface (API). One exemplary social networking website is Facebook. Facebook's API, in conjunction with the Facebook Query Language (FQL), for example, allows a developer to access the data points necessary to create a scoring template with different data elements. Each of these data elements is then multiplied by a weighting factor that is used to assign different values to various activities. These weighted data elements are aggregated to create a subtotal. Bonus points are earned through the use of incentive activities created as desired and assigned a specific number of points that will be awarded once the activity is complete. These bonus points are tallied and added to the subtotal, providing the player's total score. While Facebook is used as an example here, similar APIs and Query Languages are available for other social networking environments, such as LinkedIn and Twitter and, as such, this technology is applicable to any social networking website.

In various embodiments, scores, including bonus points, are redeemed for cash, prizes, or services. In addition, scores can also be used in a rewards system. In such a rewards system, users can build points to certain levels in order to redeem cash prizes, or services.

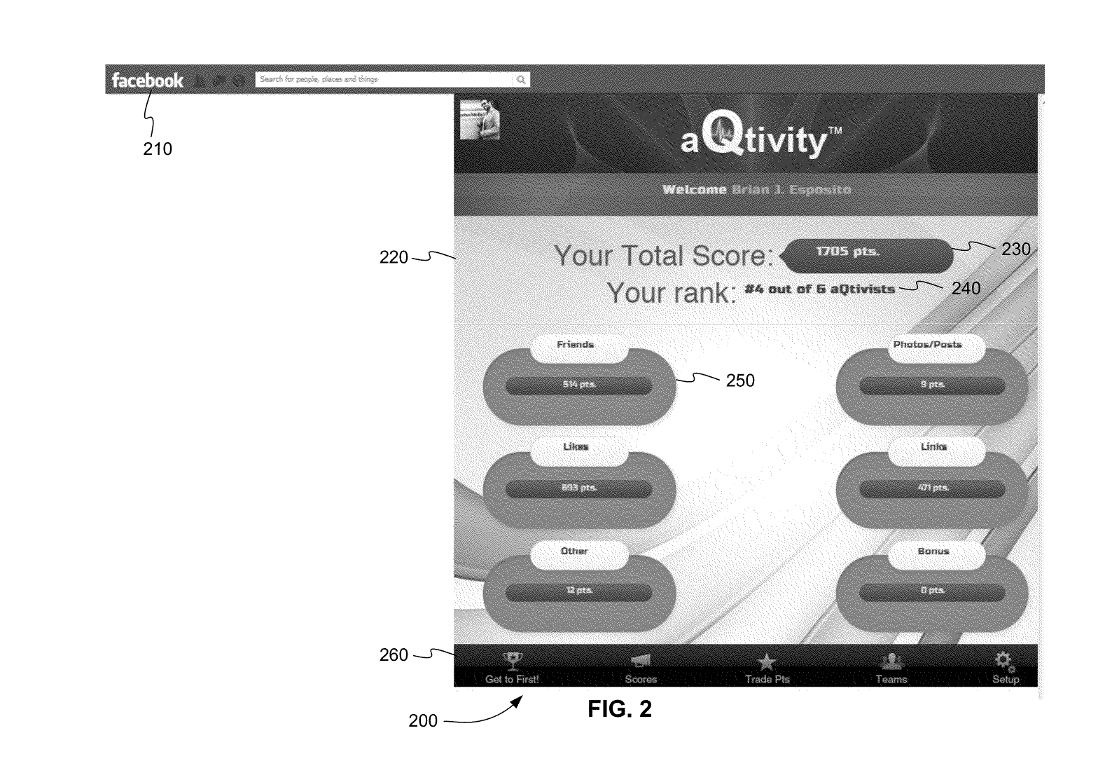

FIG. 2 is an exemplary screenshot 200 of a window 220 of a social networking website usage game application from a social networking website 210 that shows a user's total score 230, current ranking with respect to other users 240, and sub-scores for various social networking website activity 250, in accordance with various embodiments. Window 220 also includes menu bar 260 that allows a user to select other game functions. These other game functions include, but are not limited to, a get to first function, a function to see other scores, a points trading function, and a settings function. The various functions are selected by clicking on the icons in menu bar 260, for example.

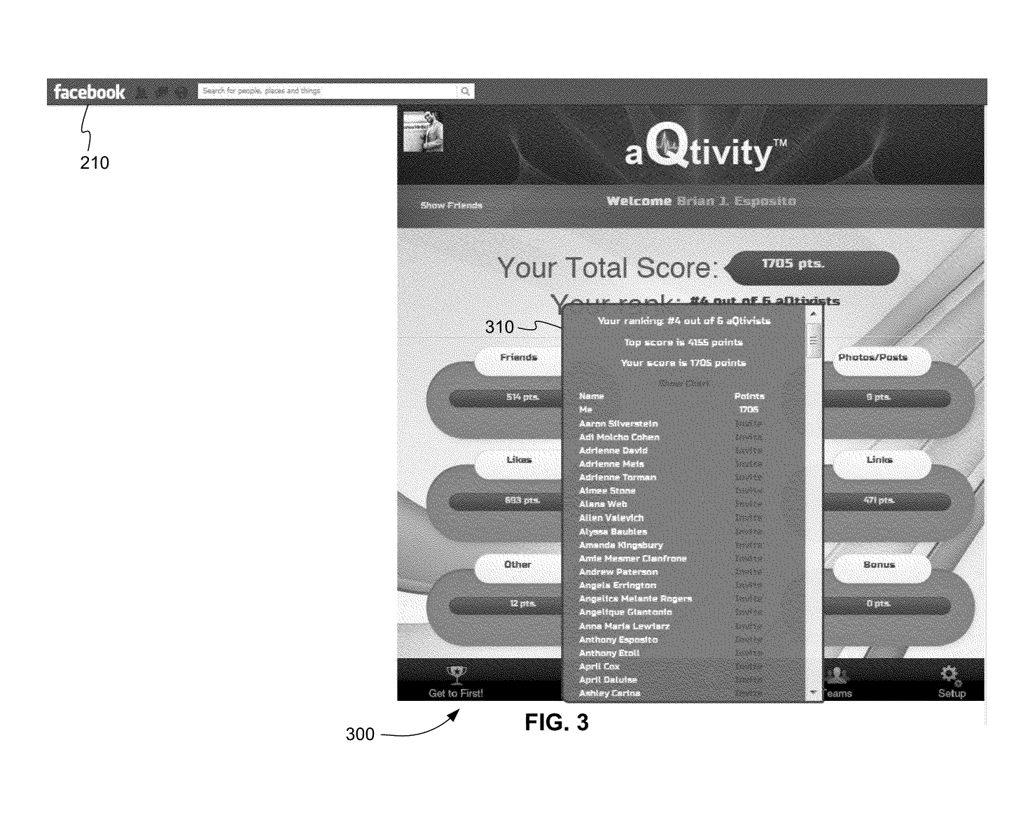

FIG. 3 is an exemplary screenshot 300 of a window 310 of a social networking website usage game application from a social networking website 210 that shows friends that can be invited to join the social networking website usage game application, in accordance with various embodiments. Window 310 can also be used to find additional scoring information.

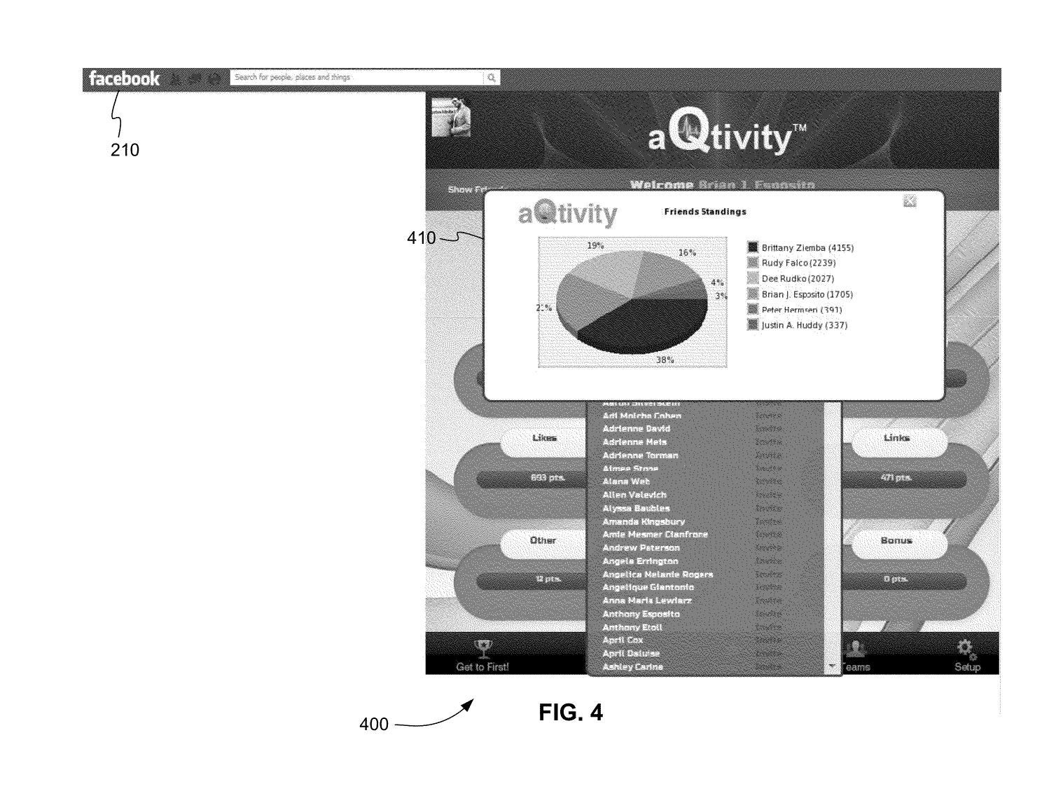

FIG. 4 is an exemplary screenshot 400 of a window 410 of a social networking website usage game application from a social networking website 210 that shows the standings or rankings of friends' game scores in graphical form, in accordance with various embodiments.

System for Providing a Game within a Social Networking Website that Uses Usage Information from the Social Networking Website to Score the Game

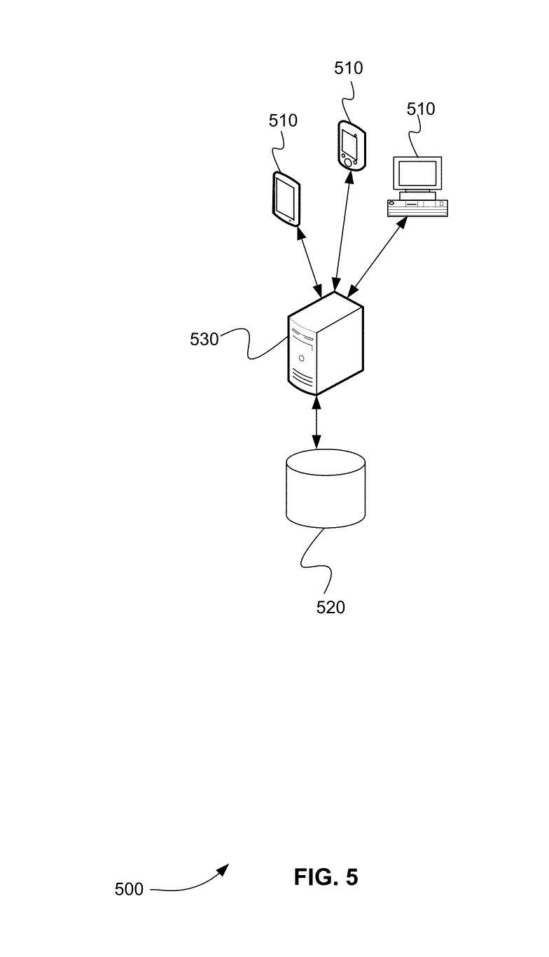

FIG. 5 is a schematic diagram of a system 500 for providing a game within a social networking website that uses usage information from the social networking website to score the game, in accordance with various embodiments. System 500 includes one or more client devices 510, one or more databases 520, and one or more computer servers 530. One or more client devices 510 can include, but are not limited to, smartphones, wearable computers, tablet computers, personal digital assistants, music players, game players, or personal computers.

One or more databases 520 store social networking website usage information of a social networking website. Data elements of the social networking website usage information can include, but are not limited to, the number of photographs uploaded, number of posts, number of likes, number of links posted, number of friends, number of times profile updated, number of times profile photograph updated, number of posts viewed, number of logins, or number of recommendations made. One or more databases 520 can include any type of electronic or magnetic storage. Although these data elements are described above as numbers of social networking events, one of ordinary skill in the art can appreciate that these data elements can also include the element of time. For example, data elements can be frequencies of events or a number of events within a given time period. Similarly, incentives or bonus points can also be given for performing a number of events within a given time period.

One or more computer servers 530 are in communication with one or more client devices 510 and one or more databases 520. One or more computer servers 530 can be any type of computer system, such as the computer system of FIG. 1. One or more computer servers 530 access the social networking website usage information from one or more databases 520. One or more computer servers 530 calculate a game score for one or more users of the social networking website based on the social networking website usage information. One or more computer servers 530 display the game score to the one or more users on one or more client devices 510. The game score is displayed on one or more client devices 510 through a webserver or through communication with an application running on one or more client devices 510.

In various embodiments, one or more computer servers 530 calculate a game score for one or more users by creating a scoring template with one or more data elements from the usage information, multiplying each data element by a weighting factor, and combining the weighted data elements into the game score. Combining the weighted elements into the game score comprises adding the weighted data elements.

In various embodiments, in addition to scoring the social networking activity that has occurred, one or more computer servers 530 display incentives to the one or more users. These incentives include, for example, bonus points for specific incentive activities. More specifically, one or more computer servers 530 further display a specific number of bonus points to be awarded to the one or more users after one or more incentive activities are completed and store the number of bonus points in one or more databases 520.

In various embodiments, bonus points can be displayed and redeemed for one or more incentive activities performed within the social networking website. Incentive activities performed within the social networking website include, but are not limited to, uploading a photograph, posting, liking, posting a link, friending or linking other members, updating profile, updating profile photograph, viewing posts, logging in, or recommending other members.

In various embodiments, bonus points can also be displayed and redeemed for one or more incentive activities performed outside of the social networking website. One or more incentive activities performed outside of the social networking website can include activity performed in other websites or offline activity. Offline activity can include, for example, donating time or money to a charity. The offline activity can be recorded, for example, through user or organization posts to the social networking website.

In various embodiments, bonus points are combined with the total score. One or more computer servers 530 monitor one or more databases 520 for usage information related to the one or more incentive activities. Upon determining that an incentive activity has occurred, one or more computer servers 530 access one or more databases 520 to determine the number of bonus points for the determined incentive activity and combine the number of bonus points with the total score for a user who performed the determined incentive activity.

Method for Providing a Game within a Social Networking Website that Uses Usage Information from the Social Networking Website to Score the Game

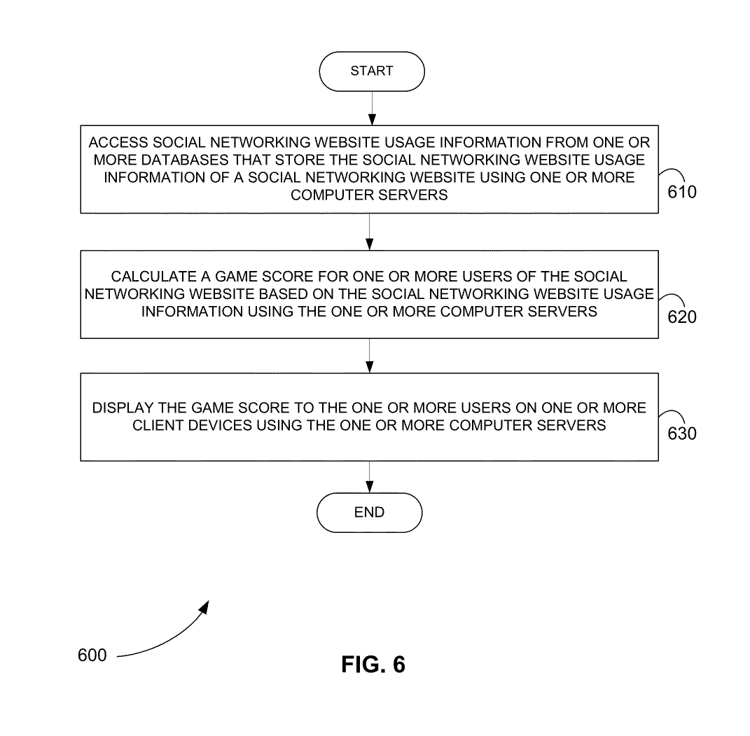

FIG. 6 is a flowchart showing a method 600 for providing a game within a social networking website that uses usage information from the social networking website to score the game, in accordance with various embodiments.

In step 610 of method 600, social networking website usage information is accessed from one or more databases that store the social networking website usage information of a social networking website using one or more computer servers.

In step 620, a game score is calculated for one or more users of the social networking website based on the social networking website usage information using the one or more computer servers.

In step 630, the game score is displayed to the one or more users on one or more client devices using the one or more computer servers.

Computer Program Product for Providing a Game within a Social Networking Website that Uses Usage Information from the Social Networking Website to Score the Game

In various embodiments, computer program products include a tangible computer-readable storage medium whose contents include a program with instructions being executed on a processor so as to perform a method for providing a game within a social networking website that uses usage information from the social networking website to score the game. This method is performed by a system that includes one or more distinct software modules

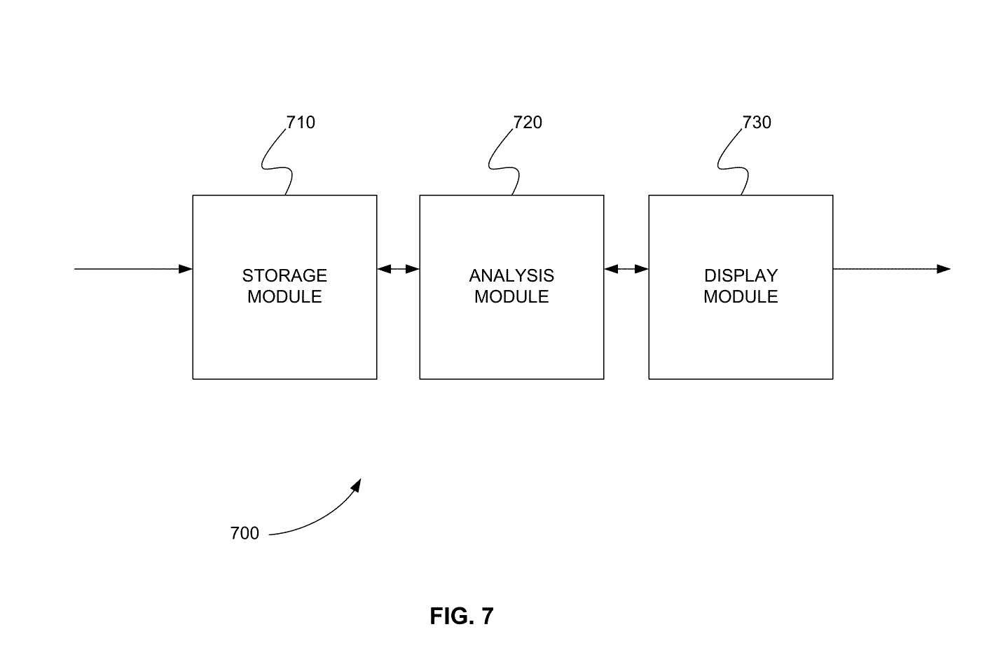

FIG. 7 is a schematic diagram of a system 700 that includes one or more distinct software modules that performs a method for providing a game within a social networking website that uses usage information from the social networking website to score the game, in accordance with various embodiments. System 700 includes storage module 710, analysis module 720, and display module 730.

Storage module 710 accesses social networking website usage information from one or more databases that store the social networking website usage information of a social networking website. Analysis module 720 calculates a game score for one or more users of the social networking website based on the social networking website usage information. Display module 730 displays the game score to the one or more users on one or more client devices.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for providing a game within a social networking website that uses usage information from the social networking website to score the game, comprising:
one or more client devices;
one or more databases that store social networking website usage information of a social networking website; and
one or more computer servers in communication with the one or more client devices and the one or more databases and that
access the social networking website usage information from the one or more databases,
calculate a game score for one or more users of the social networking website based on the social networking website usage information, and
display the game score to the one or more users on the one or more client devices.

2. The system of claim 1, wherein the one or more client devices are one or more of smartphones, wearable computers, tablet computers, personal digital assistants, music players, game players, or personal computers.

3. The system of claim 1, wherein data elements of the social networking website usage information include number of photographs uploaded, number of posts, number of likes, number of links posted, number of friends, number of times profile updated, number of times profile photograph updated, number of posts viewed, number of logins, or number of recommendations made.

4. The system of claim 1, wherein the one or more computer servers calculate a game score for one or more users by
creating a scoring template with one or more data elements from the usage information,
multiplying each data element by a weighting factor, and
combining the weighted data elements into the game score.

5. The system of claim 4, wherein combining the weighted elements into the game score comprises adding the weighted data elements.

6. The system of claim 1, wherein the one or more computer servers further display a specific number of bonus points to be awarded to the one or more users after one or more incentive activities are completed and store the number of bonus points in the one or more databases.

7. The system of claim 6, wherein the one or more incentive activities include activities performed within the social networking website.

8. The system of claim 7, wherein the incentive activities include uploading a photograph, posting, liking, posting a link, friending or linking other members, updating profile, updating profile photograph, viewing posts, logging in, or recommending other members.

9. The system of claim 6, wherein the one or more computer servers monitor the one or more databases for usage information related to the one or more incentive activities, and upon determining that an incentive activity has occurred, access the one or more databases to determine a number of bonus points for the determined incentive activity and combine the number of bonus points with the total score for a user who performed the determined incentive activity.

10. The system of claim 6, wherein the one or more incentive activities include activities performed outside of the social networking website.

11. A method for providing a game within a social networking website that uses usage information from the social networking website to score the game, comprising:
accessing social networking website usage information from one or more databases that store the social networking website usage information of a social networking website using one or more computer servers;
calculating a game score for one or more users of the social networking website based on the social networking website usage information using the one or more computer servers; and
displaying the game score to the one or more users on one or more client devices using the one or more computer servers.

12. The method of claim 11, wherein data elements of the social networking website usage information include number of photographs uploaded, number of posts, number of likes, number of links posted, number of friends, number of times profile updated, number of times profile photograph updated, number of posts viewed, number of logins, or number of recommendations made.

13. The method of claim 11, wherein calculating a game score comprises
creating a scoring template with one or more data elements from the usage information,
multiplying each data element by a weighting factor, and
combining the weighted data elements into the game score.

14. The method of claim 13, wherein combining the weighted elements into the game score comprises adding the weighted data elements.

15. The method of claim 11, further comprising
displaying a specific number of bonus points to be awarded to the one or more users after one or more incentive activities are completed and storing the number of bonus points in the one or more databases using the one or more computer servers.

16. The method of claim 15, wherein the one or more incentive activities include activities performed within the social networking website.

17. The method of claim 16, wherein the incentive activities include uploading a photograph, posting, liking, posting a link, friending or linking other members, updating profile, updating profile photograph, viewing posts, logging in, or recommending other members.

18. The method of claim 17, further comprising
monitoring the one or more databases for usage information related to the one or more incentive activities using the one or more computer servers, and
upon determining that an incentive activity has occurred, accessing the one or more databases to determine a number of bonus points for the determined incentive activity and combining the number of bonus points with the total score for a user who performed the determined incentive activity using the one or more computer servers.

19. The method of claim 15, wherein the one or more incentive activities include activities performed outside of the social networking website.

20. A computer program product, comprising a non-transient, tangible computer-readable storage medium whose contents include a program with instructions being executed on a processor so as to perform a method for providing a game within a social networking website that uses usage information from the social networking website to score the game, the method comprising:
providing a system, wherein the system comprises distinct software modules, and wherein the distinct software modules comprise a storage module, an analysis module, and a display module;
accessing social networking website usage information from one or more databases that store the social networking website usage information of a social networking website using the storage module;
calculating a game score for one or more users of the social networking website based on the social networking website usage information using the analysis module; and
displaying the game score to the one or more users on one or more client devices using the display module.
